(19) United States
(12) Patent Application Publication
(10) Pub. No.: US 2020/0019674 A1
(43) Pub. Date: Jan. 16, 2020

(54) GRANULAR ELECTION OF PREDICTIVE POLYGENIC MODELS

(71) Applicant: Helix OpCo, LLC, San Carlos, CA (US)

(72) Inventors: Ryan P. Trunck, Denver, CO (US); Rani K. Powers, Broomfield, CO (US); Christopher M. Glode, Denver, CO (US)

(21) Appl. No.: 16/033,983

(22) Filed: Jul. 12, 2018

(51) Int. Cl. G06F 19/14; G06F 19/24

(52) U.S. Cl. CPC G06F 19/14; G06F 19/24

(57) ABSTRACT

Systems and methods are provided for selecting from among polygenic models that predict characteristics of individuals. One embodiment is a genetic prediction server that includes a memory that stores polygenic models which predict characteristics of individuals based on genetic variants of the individuals, including a set of polygenic models for a characteristic that each perform a different analysis of genetic variants when making a prediction. The server also includes a controller that receives an indication of genetic variants of an individual, determines that the individual belongs to a demographic, and selects, based on the demographic, a polygenic model from the set to predict the characteristic for the individual.

### FIELD

The disclosure relates to the field of genomics, and in particular, to predicting the characteristics of individuals based on their genetics.

### BACKGROUND

The genes of individuals code for a variety of proteins. The expression of a gene in messenger Ribonucleic Acid (mRNA) and protein contributes to a variety of phenotypic traits (i.e., observable traits such as eye color, hair color, etc.) as well as other traits. Genetic factors therefore play a major role in a variety of phenotypic traits. For example, normal variations (polymorphisms) in two genes, EDAR and FGFR2, have been associated with differences in hair thickness. Each variation in the nucleotides found in a gene (or the nucleotides that regulate expression of that gene) may be considered a genetic variant.

While biological inheritance of physical traits has been studied for decades, associating specific phenotypes with specific genetic variants or combinations thereof remains a complicated process. The human genome itself occupies approximately eighty Gigabytes (GB) of data. Furthermore, there are estimated to be roughly ten million Single Nucleotide Polymorphisms (SNPs) within the genome. Large stretches of the genome include non-coding regions (e.g., introns) as well as coding regions (e.g., exons), and the non-coding regions may regulate how one or more coding regions are expressed. Thus, even variations in non-coding regions may have an impact on phenotype, and false positives may occur when associating a genetic variant with a specific phenotype. Hence, the process of correlating specific genetic variants with specific traits (e.g., specific phenotypes) can be fiendishly complex.

Further increasing the complexity of this process, it is not possible to identify many traits of an individual without studying the individual closely, and some traits may be hard to precisely quantify (e.g., hair curl, personality, etc.). Other traits may be hard to identify based on the information currently known about the individual. For example, an individual who has constant headaches may be suffering from high blood pressure, high stress, allergies, or other conditions. Without more information, it would be impossible to determine which genetic variants within that individual are correlated with (and/or contribute to) the reported traits.

Models have been built which attempt to predict the traits of an individual based on the genotype of that individual. However, the accuracy, speed, and complexity of such models varies wildly. Further compounding this issue, new models for predicting an individual trait may be published on an almost daily basis, making it hard to determine which models, if any, are most relevant to the individual. Hence, those who seek to identify relationships between traits of individuals and the genetic variants found in those individuals continue to seek out enhanced systems and methods for achieving these goals.

### SUMMARY

Embodiments described herein provide systems and techniques for selecting a polygenic model that will make a prediction about a specific characteristic (e.g., height, weight, eye color, etc.) of an individual based on the genetic variants determined to exist within that individual. Specifically, embodiments described herein are capable of determining one or more demographics that the individual belongs to, and dynamically selecting from many available polygenic models based on these demographics. Because the selected polygenic model is targeted to the demographic(s) that the individual belongs to, the resulting predictions made by the selected polygenic model are likely to be more accurate than polygenic models which are generic, or are targeted to other demographics. This in turn increases the accuracy of the predictive process.

The techniques and systems provided herein may be particularly relevant in environments where hundreds or thousands of traits are predicted for an individual, and where there are hundreds or thousands of polygenic models that could be used to predict each of those traits. In the event that there are many polygenic models which are partially relevant to the individual (e.g., because they match some, but not all, of the demographics of the individual), embodiments described herein may determine which polygenic model is best suited for that individual.

One embodiment is a genetic prediction server that includes a memory that stores polygenic models which predict characteristics of individuals based on genetic variants of the individuals (i.e., genetic variants that are included within the genetic makeup of the individuals), including a set of polygenic models for a characteristic that each perform a different analysis of genetic variants when making a prediction. The server also includes a controller that receives an indication of genetic variants exhibited by an individual, determines that the individual belongs to a demographic, and selects, based on the demographic, a polygenic model from the set to predict the characteristic for the individual.

A further embodiment is a method. The method includes identifying polygenic models which predict characteristics of individuals based on genetic variants exhibited by the individuals, including a set of polygenic models for a characteristic that each perform a different analysis of genetic variants when making a prediction, receiving an indication of genetic variants of an individual (i.e., genetic variants that are included within the genetic makeup of the individual), determining that the individual belongs to a demographic, and selecting, based on the demographic, a polygenic model from the set to predict the characteristic for the individual.

Yet another embodiment is a non-transitory computer readable medium embodying programmed instructions which, when executed by a processor, are operable for performing a method. The method includes identifying polygenic models which predict characteristics of individuals based on genetic variants of the individuals, including a set of polygenic models for a characteristic that each perform a different analysis of genetic variants when making a prediction, receiving an indication of genetic variants of an individual, determining that the individual belongs to a demographic, and selecting, based on the demographic, a polygenic model from the set to predict the characteristic for the individual.

Other illustrative embodiments (e.g., methods and computer-readable media relating to the foregoing embodiments) may be described below. The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a block diagram of a polygenic prediction system in an illustrative embodiment.

FIG. 2 is a flowchart illustrating a method for operating a polygenic prediction system in an illustrative embodiment.

FIG. 3 is a block diagram of a polygenic model that receives input defining known genetic variants corresponding with predetermined genetic loci in an illustrative embodiment.

FIG. 4 provides tables that rank demographic categories for different characteristics in an illustrative embodiment.

FIG. 5 is a diagram illustrating selection of a polygenic model in an illustrative embodiment.

FIG. 6 is a further diagram illustrating selection of a polygenic model in an illustrative embodiment.

FIG. 7 is a diagram illustrating a plurality of models of varying demographic granularity in an illustrative embodiment.

FIG. 8 is a table illustrating a Variant Call Format (VCF) file that has been modified to report demographics for an individual in an illustrative embodiment.

FIG. 9 is a table illustrating a customized Browser Extensible Data (BED) file that indicates demographics for multiple individuals in an illustrative embodiment.

FIG. 10 depicts an illustrative computing system operable to execute programmed instructions embodied on a computer readable medium.

### DESCRIPTION

The figures and the following description depict specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

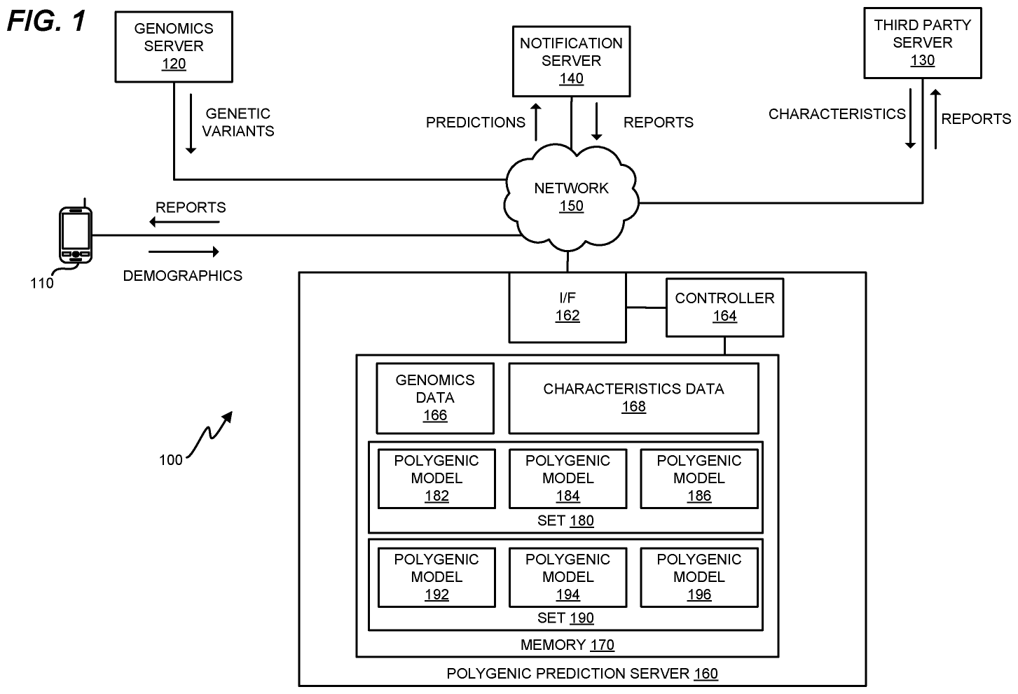

FIG. 1 is a block diagram of a polygenic prediction system 100 in an illustrative embodiment. Polygenic prediction system 100 comprises any system, device, or component that dynamically selects and operates polygenic models which make predictions about individuals based on the genetic variants of those individuals. Specifically, polygenic prediction system 100 considers the demographics that the individual belongs to when selecting a polygenic model to predict a characteristic of the individual.

In this embodiment, polygenic prediction system 100 includes user device 110 (e.g., a computer, cellular phone, or tablet of a user), genomics server 120, and one or more third party servers 130. These entities provide input via network 150 (e.g., the Internet, a combination of small networks, etc.) to polygenic prediction server 160. For example, user device 110 may provide login information, commands, authorizations, and user feedback; genomics server 120 may provide records (e.g., Variant Call Format (VCF) files, Browser Extensible Data (BED) files, other formats) indicating genetic variants of an individual; and third party server 130 may provide information describing characteristics or preferences of an individual, such as information that has been provided by the individual to a social network, to a gym, or to a genealogy website.

Polygenic prediction server 160 may use information provided by the various entities described above while coordinating the prediction of characteristics for individuals. For example, controller 164 of polygenic prediction server 160 may analyze received login information to determine whether the user has permission to access records for a specific individual in order to make predictions. If a user does have permission, controller 164 may use records from genomic data server 120 as input to polygenic models 182-186 and/or polygenic models 192-196 in order to generate predictions about the individual.

The polygenic models may comprise machine learning models (e.g., neural networks, genetic algorithms, other stochastic or deterministic models, etc.) that have already been trained based on a vetted set of training data, may comprise other predictive models (e.g., statistical models, linear or non-linear models), etc. While only six polygenic models are illustrated in FIG. 1, any suitable number of models may be utilized by polygenic prediction server 160.

A polygenic model will make a prediction (e.g., the predicting the value, existence, or nonexistence of a characteristic; predicting a set of characteristics, etc.) for an individual. Each polygenic model considers the existence (or nonexistence) of specific genetic variants at the individual when making predictions. For example, each polygenic model may expect to receive information describing genetic variants for an individual that occupy predetermined genetic loci (e.g., locations on a chromosome, locations within the genome as a whole, a range of locations on a chromosome, etc.). The predetermined genetic loci may vary between polygenic models. For example, polygenic model 172 may expect information describing three Single Nucleotide Polymorphisms (SNPs) at three separate predetermined genetic loci on a chromosome, while polygenic model 184 may expect four genetic sequences that each occupy a range of predetermined genetic loci on a different chromosome. The number of predetermined genetic loci considered by each model may vary widely, such as from hundreds to hundreds of thousands.

As shown in FIG. 1, the polygenic models are subdivided into set 180 and set 190. Polygenic models within each set predict the same characteristic (e.g., height, weight, eye color, hair color, cardiovascular health, etc.), and polygenic models of different sets may predict different characteristics. For example, polygenic models 182-186 may predict height, while polygenic models 192-196 may predict eye color. Each polygenic model within a set performs a different analysis of genetic variants when making a prediction. For example, different polygenic models within a set may weigh certain genetic variants differently when making a prediction, may perform different calculations based upon the genetic variants of an individual, or may use different genetic variants as inputs. In one embodiment, each polygenic model within a set is trained using known genotypes and known characteristics for members of a different demographic.

Because individual polygenic models have been calibrated for specific demographics, the overall accuracy of predictions made for an individual may be beneficially increased by selecting a polygenic model calibrated for a demographic that the individual belongs to. Demographics may be groups delineated within any suitable category (e.g., age, ancestry, sex, etc.). For example, a demographic in the category of age may comprise individuals who are between sixteen and twenty-two years of age. Demographics may even be delineated across multiple categories at once, in order to provide for enhanced granularity. For example, a demographic in the category of age and the category of sex may include male individuals between the ages of sixty and seventy-four.

In this embodiment, polygenic prediction server 160 includes controller 164, which selects the polygenic model(s) that will predict each of one or more characteristics of an individual. Specifically, controller 164 selects polygenic models to predict characteristics of the individual based on the demographics to which the individual belongs. Controller 164 may be implemented, for example, as custom circuitry, as a hardware processor executing programmed instructions, or some combination thereof. Polygenic prediction server 160 also includes interface (I/F) 162. I/F 162 receives and transmits data via network 150, and may comprise any suitable component for transmitting data, such as an Ethernet port, a wireless transceiver compatible with IEEE 802.11 protocols, etc.

Controller 164 stores genomics data 166 in memory 170 based on input from genomics server 120, user device 110, and/or third party server 130. Memory 170 may comprise any suitable non-transitory computer readable storage medium, such as a solid state memory, hard disk, etc. Genomics data 166 includes records that describe known genetic variants found in at least one individual. For example, each record in genomics data 166 may indicate genetic variants of a specific individual. In further embodiments, genomics data 166 indicates the genomics of an entire population (e.g., millions of individuals) on an individual-by-individual basis. In such an embodiment, each record in genomics data 166 may indicate genetic variants found within a specific individual, and different records may correspond with different individuals. In a further embodiment, a record in genomics data 166 may report the existence (or non-existence) of a specific genetic variant for a large number of specified individuals. As used herein, the term “genetic variant” refers to a variation of an individual gene (e.g., alleles, Single Nucleotide Polymorphisms (SNPs), etc.), as well as epigenetic variations, variations in nucleotides that regulate gene expression or gene activity, etc.

Controller 164 may also store characteristics data 168 in memory 170 based on input from third party server 130 and/or user device 110. As used herein, the “characteristics” of an individual include phenotypes of an individual, such as hair color, eye color, height, etc. Characteristics may also include behaviors of the individual such as fitness patterns, dietary habits, travel patterns, social networking behaviors and preferences (e.g. “Likes” of a sports team or political party), etc. Characteristics may even include demographics such as the ancestry of an individual, the age of the individual, or the sex of an individual, and may include the “digital footprint” of an individual (e.g., interactions with others on a social network, financial transactions performed by the individual), a history of medical treatment for the individual, etc. As discussed above, the polygenic models may be used by controller 164 to predict characteristics of an individual. However, controller 164 may also provide characteristics (such as those stored in characteristics data 168) as inputs to the polygenic models when making predictions.

With the above description provided of “characteristics,” it will be understood that characteristics data 168 may include records that indicate characteristics of specific individuals. For example, characteristics data 168 may describe Electronic Health Records (EHRs), a pulse rate of an individual over time during a workout, a level of cardiovascular health, etc. In other examples, the records may indicate a pattern of purchases by an individual that suggest a specific characteristic, such as nearsightedness, acid reflux, or a desire for travel.

Controller 164 utilizes genomics data 166, optionally in combination with characteristics data 168, as inputs to one or more polygenic models, and makes predictions regarding individuals based on the output of these models. For example, a polygenic model 182 may attempt to predictively assign a characteristic to an individual, such as “lactose tolerant,” “lactose intolerant,” etc. based on the genotype and/or characteristics of that individual. Controller 164 may further indicate these predictions to notification server 140, which generates and transmit reports based on the predictions to user device 110, third party server 130, and/or any other suitable entities.

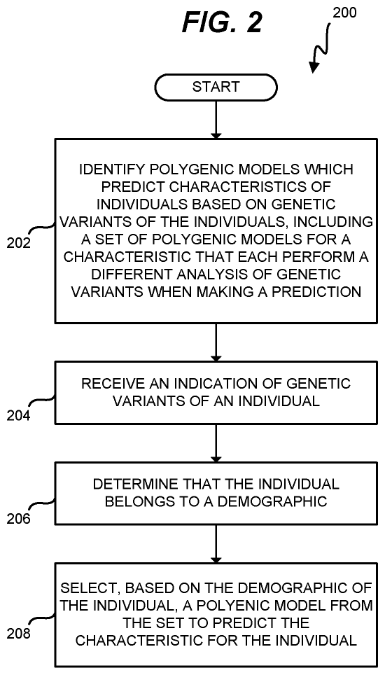

Illustrative details of the operation of polygenic prediction system 100 will be discussed with regard to FIG. 2. Assume, for this embodiment, that a user (e.g., a medical practitioner or a family member) has accessed polygenic prediction system 100 in order to make personalized predictions for an individual, based on the genetic variants of that individual. To this end, the user submits a request to polygenic prediction server 160 to make predictions regarding one or more characteristics.

FIG. 2 is a flowchart illustrating a method 200 for operating a polygenic prediction system in an illustrative embodiment. The steps of method 200 are described with reference to polygenic prediction system 100 of FIG. 1, but those skilled in the art will appreciate that method 200 may be performed in other systems. The steps of the flowcharts described herein are not all inclusive and may include other steps not shown. The steps described herein may also be performed in an alternative order.

Controller 164 of polygenic prediction server 160 receives the request from the user, and determines that the user is authorized to make the request for the individual. In response to determining that the user is authorized, controller 164 may direct I/F 162 to transmit a request to genomics server 120 for genetic variants of the individual.

In step 202, controller 164 identifies polygenic models which predict characteristics of individuals based on genetic variants of the individuals. The polygenic models include a set 180 of polygenic models 182-186 for predicting a characteristic (e.g., diving proficiency). Within set 180, each polygenic model performs a different analysis of genetic variants when making a prediction.

In step 204, controller 164 receives an indication (e.g., one or more records) of known genetic variants of the individual. The indication may comprise a list of known genetic variants, along with the genetic loci occupied by those genetic variants. The indication may be received from genomics server 120, or may already be stored in memory 170. For example, the indication may comprise a VCF file provided by genomics server 120, a BED file stored in memory 170, etc.

Controller 164 further determines at least one demographic that the individual belongs to, in step 206. This information may be included in the records from genomics server 120 or may be within a profile for the individual stored in memory 170. In one embodiment, the profile for the individual is based on information provided by a third-party server (e.g., a social network, health service, hospital, etc.) or information provided by the user. Demographics of the individual may be determined for one or multiple categories (e.g., any combination of age, sex, and/or ancestry). Demographics for the individual may even be determined for nested categories (e.g., a first demographic comprising broad range of ages, and a second demographic comprising a narrow range of ages within the first range of ages).

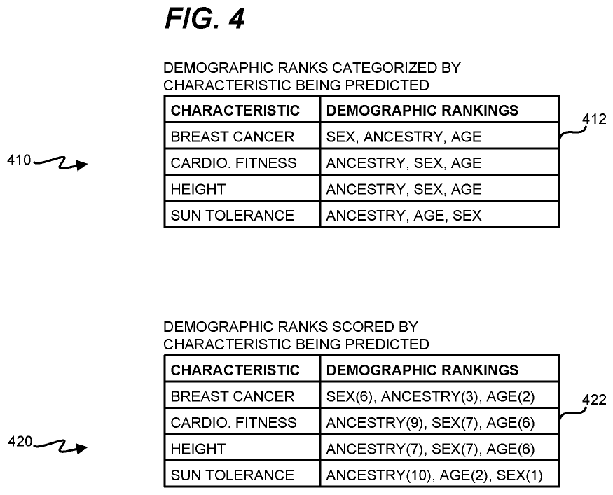

In step 208, controller 164 selects a polygenic model in the set 180 to predict the characteristic (e.g., diving proficiency) for the individual. The selection is based on the at least one demographic determined for the individual. For example, controller 164 may select a polygenic model that has been calibrated for members of the demographic. In a further example, controller 164 may select a polygenic model based on a combination of demographics that the individual belongs to. There may not necessarily be a polygenic model that precisely matches all of the demographics of the individual. Thus, controller 164 may engage in a ranking or scoring process in order to select from a variety of polygenic models that match some, but not all, of the demographics of the individual. Further details of illustrative ranking and/or scoring systems are described below with regard to FIGS. 4-6.

Controller 164 proceeds to operate the selected polygenic model to make a prediction of the characteristic (e.g., diving proficiency) for the individual. For example, if the selected polygenic model is a neural network, controller may apply the genetic variants as input to the neural network and determine an output. In a further example, if the selected polygenic model is an equation, controller 164 may consider the existence or nonexistence of known genetic variants to selectively include or omit (or set to null or zero) segments of the equation.

Controller 164 may further generate and transmit the predicted characteristic to notification server 140 for provisioning to the user. Notification server 140 receives the prediction from polygenic prediction server 160 via network 150, and generates and transmits reports to genomics server 120, third party server 130, and/or one or more user devices 110. The reports include the prediction itself, and may be accompanied by descriptive or contextual information relating to the prediction. In this manner, reports are provided to those who have an interest in the predictions made by polygenic prediction server 160. Notification server 140 may further anonymize personal data for the individual within the reports if desired, in order to ensure that privacy is maintained. For example, if a report is provided to a third party, the report may be anonymized to protect the privacy of the individual. Reports may also be utilized to develop applications pertaining to polygenic prediction server 160, and/or for internal research.

Method 200 provides a substantial advantage over prior techniques in that it enables the storage and dynamic selection of polygenic models that each predict the same characteristic in a different manner. Polygenic prediction server 160 considers the demographics of the individuals that it makes predictions for, and is capable of using demographic information to select polygenic models on a more granular basis for an individual. This means that polygenic prediction server 160 is not limited to generic, universal polygenic models that could fail to take into account the idiosyncrasies of certain populations.

In further embodiments, method 200 may be performed in order to predict each of a variety of characteristics of the user. In such embodiments, there are sets of polygenic models for predicting each characteristic, wherein each polygenic model may be tuned for a different demographic or combination of demographics. For each characteristic that will be predicted, method 200 may select a polygenic model tuned to the demographics of the individual, meaning that many polygenic models may be used to predict many characteristics of the individual. The specific combination of models used to make predictions for an individual is therefore expected to vary substantially between individuals and is personalized based on their demographics. In embodiments where a large number of polygenic models are used to predict numerous characteristics of an individual, the predictions may be aggregated into a single report provided to the user.

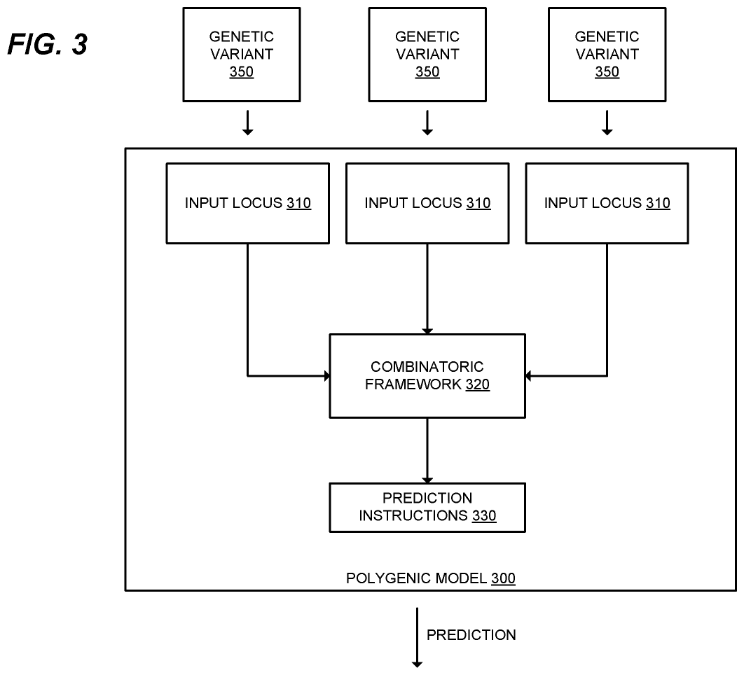

FIG. 3 is a block diagram of a polygenic model that receives input defining known genetic variants corresponding with predetermined genetic loci in an illustrative embodiment. According to FIG. 3, each input locus 310 at polygenic model 300 expects to receive information describing a genetic variant 350 (e.g., a specified nucleobase or combination of nucleobases) occupying a predetermined genetic locus, or a genetic variant 350 occupying a predetermined sequence of genetic loci. For example, an input locus 310 may expect information describing nucleobases occupying a contiguous sequence of loci at a specific chromosome. Controller 164 may use the existence or nonexistence of certain genetic variants 350 as variables within combinatoric framework 320, and may utilize results from prediction instructions 330 in order to make a prediction about one or more characteristics of an individual.

FIG. 4 provides tables that rank demographic categories for different characteristics in an illustrative embodiment. Specifically, FIG. 4 includes table 410, which ranks categories (e.g., sex, age, ancestry) of demographics, and table 420, which provides scores for different categories of demographics. Ideally, a polygenic model exists that is calibrated for each category of demographic that is known for an individual. However, it is entirely possible that no such model exists in memory 170. This makes it harder to determine which polygenic model should be used.

To address these concerns, table 410 or table 420 may be utilized to determine which polygenic model should be used to predict a characteristic of a user, when no single polygenic model for predicting the characteristic matches all of the known demographics of the user. Each entry 412 in table 410 corresponds with a different characteristic being predicted (e.g., breast cancer risk, cardiovascular fitness, sun tolerance, etc.), and provides rankings of categories that are most influential when predicting that characteristic. This ranking information may be used by controller 164 to select an optimal polygenic model, when multiple polygenic models are calibrated for different demographics that an individual belongs to.

To illustrate by way of example, an entry 412 in table 410 indicates that when predicting breast cancer risk, if a polygenic model exists that is calibrated for the sex of the individual, then that polygenic model should be selected over other polygenic models. If the sex of the individual is unknown (or if no polygenic model exists that is calibrated for the sex of the individual), then a model which is calibrated for the ancestry of the individual should be selected over a model which is calibrated for the age of the individual.

The information provided in entries 412 may also be used to determine which polygenic model to use when there are models that are calibrated for multiple demographics of the individual. For example, the breast cancer risk entry, which ranks sex, then age, and then ancestry, may be interpreted as selecting models that match the sex, ancestry, and age of the individual above all others; followed by models that match the sex and ancestry of the individual; followed by models that match the sex and age of the individual; followed by models that match the sex of the individual; followed by models that match the ancestry and age of the individual; followed by models that match the ancestry of the individual; and followed by models that match the age of the individual.

Table 420 uses a similar process, except that it provides scores for each category of demographic (e.g., age, sex, ancestry) instead of a relative ranking of polygenic models. If a model is calibrated for multiple demographics, the model may be ranked by summing the scores of each demographic that matches the individual, and comparing the sum to those of other models. For example, when making a prediction of cardiovascular fitness according to an entry 422, a model that has been calibrated for the sex and the age of the individual may have a sum of thirteen (i.e., seven plus six), while a model that has been calibrated for just the ancestry of the individual may have a sum of nine. Thus, even though the category of ancestry may have a score higher than a category of sex or age, a model that is calibrated for both the sex and the age of the individual may be preferred over a model that has been calibrated solely for the ancestry of the individual.

In further embodiments, a model may be calibrated for a sub-population that the individual belongs to. For example, if an individual is twelve years old, there may be a model that is calibrated for ages five to thirty, as well as a model that is calibrated for ages twelve to seventeen. In such scenarios, the score and/or rank determined for a model may increase if the model is calibrated for the sub-population that the individual belongs to.

The tables of FIG. 4, and/or similar schema, may be used by controller 164 when controller 164 determines that multiple polygenic models in a set are each calibrated for a population belonging to at least one of the demographics of the individual. In such an instance, controller 164 may determine a category for each of the multiple demographics, assigns a rank to each category, and selects a polygenic model that has been calibrated for a demographic in a category having the highest rank (so long as the user in fact belongs to that demographic).

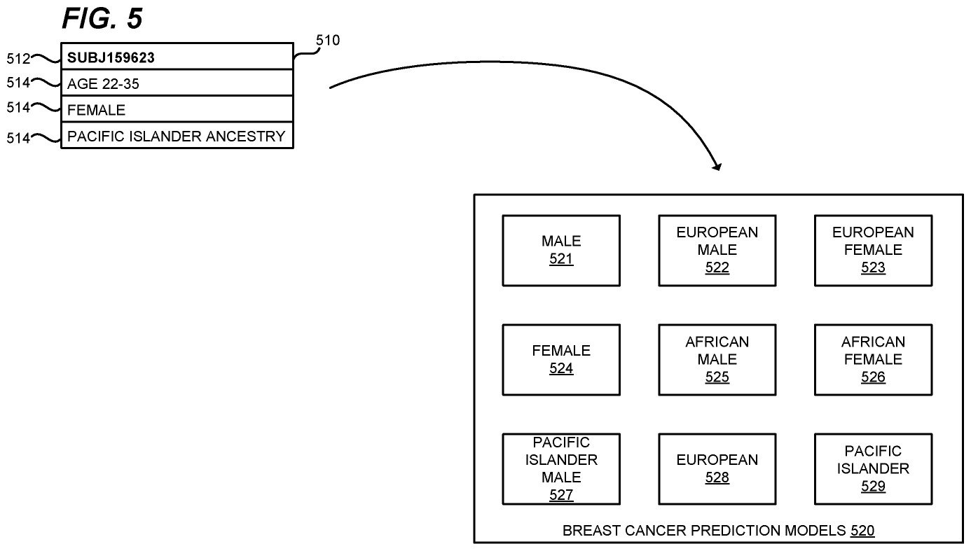

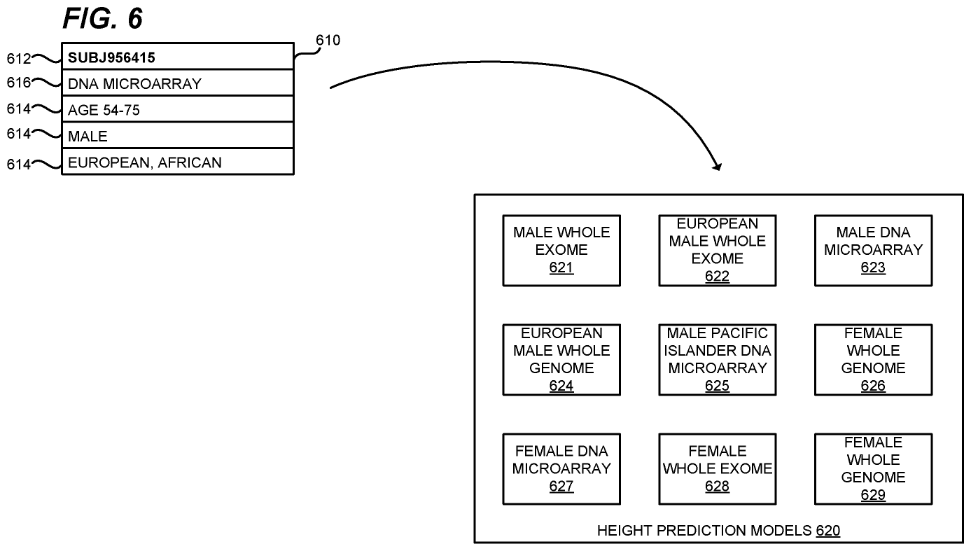

FIGS. 5-6 illustrate scenarios where an individual belongs to multiple demographics, but there is no specific polygenic model that corresponds with these demographics of the individual. Specifically, FIG. 5 is a diagram 500 illustrating selection of a polygenic model in an illustrative embodiment. According to FIG. 5, demographic information 510 for an individual has been provided, and is being used to determine which polygenic model to use when predicting breast cancer risk. The demographic information 510 includes an anonymized identifier 512 of the individual, and multiple demographics 514 of the individual. For example, the demographics include an age range that the individual belongs to, an ancestry of the individual, and a sex of the individual.

In this example, there are a variety of breast cancer prediction models 520. Specifically, models exist for male 521, for European male 522, for European female 523, for female 524, for African male 525, for African female 526, for Pacific Islander male 527, for European 528 (of either sex), and for Pacific Islander 529 (of either sex). None of the models have been calibrated for the age range that the individual belongs to. However, models do exist which have been calibrated for the ancestry of the individual, and models do exist which have been calibrated for the sex of the individual. In the present instance, models which have been calibrated based on sex are prioritized for selection, followed by ancestry, and then age. Hence, the model for female 524 is chosen, because there is no ancestry-calibrated model which matches both the sex and the ancestry of the individual.

FIG. 6 is a further diagram illustrating selection of a polygenic model in an illustrative embodiment. Demographic information 610 for an individual has been provided, and is being used to determine which polygenic model to use when predicting height. The demographic information 610 includes an anonymized identifier 612 of the individual, and multiple demographics 614 of the individual. In this example, the individual is a male of both African and European ancestry between the ages of fifty-four and seventy-five. Furthermore, the demographic information includes an entry 616 indicating that the individual's genetic variants have been reported in the form of a Deoxyribonucleic Acid (DNA) microarray. This means that only a portion of the individual's exome (e.g., comprising a few hundred thousand Single Nucleotide Polymorphisms (SNPs)) has been genotyped/provided as input, and no information is available describing the whole exome or whole genome of the individual.

Height prediction models 620 include male whole exome 621, European male whole exome 622, male DNA microarray 623, European male whole genome, 624 male Pacific Islander DNA microarray 625, female whole genome 626, female DNA microarray 627, female whole exome 628, and female whole genome 629. Controller 164 discards models which use different genetic variants than indicated in the DNA microarray. Thus, controller 164 prevents selection of (e.g., discards, disqualifies) models which utilize whole exome or whole genome data, because these models require vastly more genetic variants as inputs than have been provided by the DNA microarray.

After models have been disqualified/discarded based on the amount of data, the remaining models are male DNA microarray 623, male Pacific Islander DNA microarray 625, and female DNA microarray 627. Controller 164 elects the male DNA microarray 623 to perform prediction of height, because the individual does not have Pacific Islander ancestry and is not female.

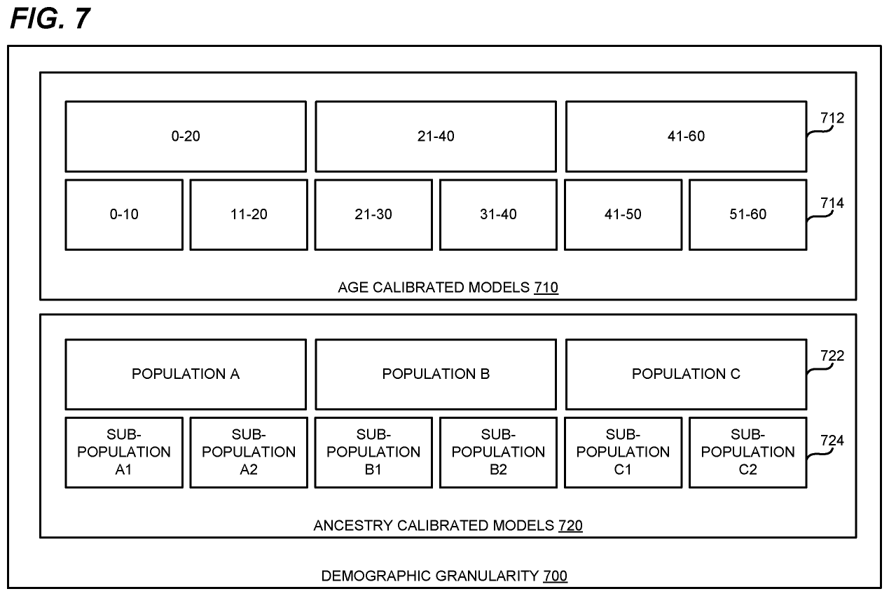

FIG. 7 is a diagram illustrating a plurality of models of varying demographic granularity 700 in an illustrative embodiment. In this embodiment, polygenic models are calibrated by age or ancestry. However, some polygenic models are categorized based on broader demographics of age or ancestry, while other polygenic models are categorized based on narrower demographics of age or ancestry. For example, some age calibrated models 710 are calibrated for broad demographics 712 (e.g., ages 0-20, 21-40, 41-60), while others are calibrated for narrow demographics 714 which are within broad demographics 712 (e.g., ages 0-10, 11-20, 21-30, 31-40, 41-50, 51-60). Similarly, some ancestry calibrated models 720 are calibrated for broad demographics 722 (e.g., population A, population B, population C), while others are calibrated for narrow demographics 724 within broad demographics 722 (e.g., subpopulation A1, subpopulation A2, subpopulation B1, subpopulation B2, subpopulation C1, subpopulation C2).

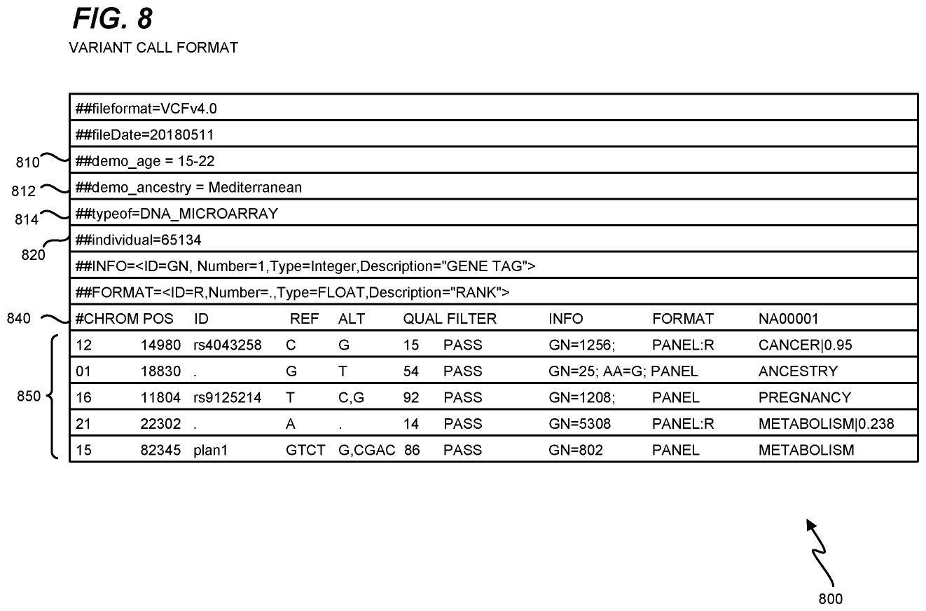

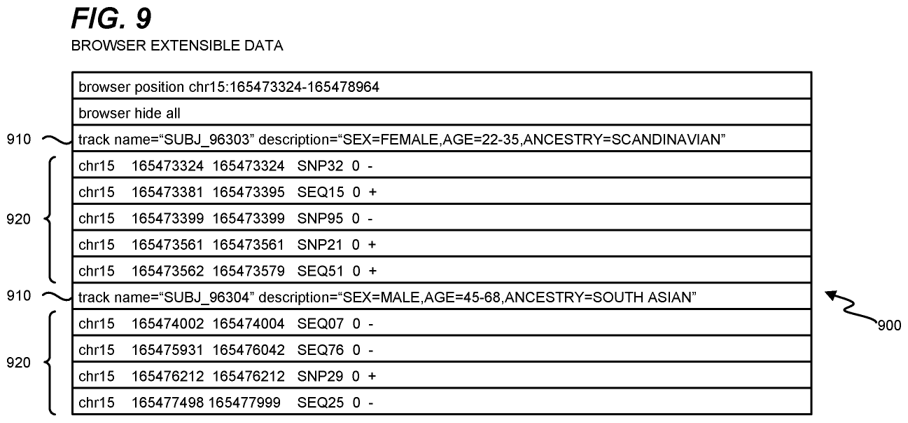

FIGS. 8-9 illustrate modifications to various genomic reporting formats that may enhance the ease of performing the processes described above. Specifically, FIG. 8 is a table illustrating a VCF file 800 that has been modified to include demographic information for an individual in an illustrative embodiment. Genomics server 120 may provide such modified VCF files to genomic prediction server 160 for processing. VCF file 800 includes multiple lines 850 that follow header line 840. Each of the multiple lines 850 reports one or more genetic variants of an individual. VCF file 800 has been modified to include one or more meta-information lines (included after the characters “##”) with a key-value pair that defines a category of demographic (e.g., age, ancestry), as well as a demographic within the category (e.g., fifteen to twenty-two years old, Mediterranean) for the user. This includes meta-information line 810 which indicates a demographic for age, and meta-information line 812 which indicates a demographic for ancestry. VCF file 800 also includes a meta-information line 814 indicating the type of analysis that was performed upon the user's DNA (e.g., DNA microarray, whole exome, whole genome), as well as a unique, anonymous identifier 820 for the individual. Controller 164 may access this information when selecting a polygenic model for the individual.

FIG. 9 is a table illustrating a customized BED file 900 that indicates demographics for multiple individuals in an illustrative embodiment. BED file 900 describes how genomic data in a binary BED file (not shown) is formatted. Hence, BED file 900 does not include the genomic data itself, but rather operates as an index or reference for genomic data in an accompanying binary BED file, indicating where specific segments of genomic data may be accessed from a binary BED file. BED file 900, and the accompanying binary BED file, may be transmitted to authorized users via genomics server 120.

As shown in FIG. 9, BED file 900 includes multiple annotations which are introduced by header lines 910. Each header line 910 includes a name and a description. The name is set to an anonymized identifier for an individual, and the description provides a comma separated list of demographics that the individual belongs to. The specific segments of genomic data for each individual are indicated by lines 920 following each header line 910. In this manner, the demographics and genomics of multiple individuals may be reported via a BED file.

### EXAMPLES

In the following examples, additional processes, systems, and methods are described in the context of a polygenic prediction system.

In this embodiment, an individual logs in to polygenic prediction server 160, and requests a set of predictions relating to their own cardiovascular health as well as likelihood of developing Alzheimer's later in life. Controller 164 of polygenic prediction server 160 loads a profile of the individual, and determines that the individual's demographics are known for categories of age, ancestry, sex, and nation of residence. The individual's demographics are age 27-42, age 32-35, European ancestry, Dutch ancestry, Pacific Islander ancestry, male, residence in United States of America. Controller 164 also contacts genomic server 120 and determines that whole exome data (describing genetic variants of the individual across the entire exome (i.e., the protein coding portions of the genome) of the individual) is available, but that whole genome data does not exist for the individual.

Having determined the demographics of the individual as well as the genetic variants of the individual, controller 164 proceeds to initiate the prediction process. Controller 164 therefore begins the process of selecting a polygenic model to be used in predicting cardiovascular fitness.

Controller 164 determines that there are multiple polygenic models that may be used to predict the characteristic of cardiovascular health, and that there are also multiple polygenic models that may be used to predict the characteristic of likelihood of developing Alzheimer's. For each characteristic, there is a set of models that have been calibrated for a different demographic. Controller 164 proceeds to disqualify any models that utilize whole genome data, as this data does not exist for the individual. Controller 164 keeps models that use DNA microarrays as well as models that utilize whole exome data, because whole exome data includes genetic variants that would be used as input to the DNA microarray models. Controller 164 also disqualifies models that have been calibrated for demographics that the individual does not belong to. Thus, controller 164 disqualifies models that have been calibrated for demographics such as “age 1-12,” “African ancestry,” “female sex,” etc.

Controller 164 determines that multiple polygenic models remain for predicting cardiovascular health which have been calibrated for the demographics of the user. Controller 164 therefore consults a table which indicates how different categories of demographics are ranked. Controller 164 determines that the most impactful category of demographic when predicting cardiovascular health based on genetic variants is sex, followed by ancestry, followed by age. Controller 164 identifies seven models that have been calibrated for males, three of which have been calibrated for European ancestry, and two of which have been calibrated for Pacific Islander ancestry. Controller 164 reviews the profile of the individual, and determines that the individual has a greater percentage of European ancestry than Pacific Islander ancestry. Therefore, controller 164 prioritizes the models that are calibrated for European ancestry. Two of the remaining models use a DNA microarray as input, while the other model uses whole exome data. Controller 164 selects the polygenic model that uses whole exome data to make the prediction regarding cardiovascular fitness, because whole exome models are expected to be more accurate than models which use only a DNA microarray as input.

A similar process is performed when selecting a polygenic model for predicting a likelihood of developing Alzheimer's. For this characteristic, categories of demographic are each assigned a score. Polygenic models are ranked based on the sum of scores of categories in which they have been calibrated for the demographics of the individual. For example, the age:broad category provides a score of three if the model has been calibrated for a wide age demographic that the individual belongs to, while the age:narrow category provides a score of eleven if the model has been calibrated for a narrow age demographic that the individual belongs to. By assigning numerical scores to different polygenic models calibrated for different demographic groups, the scoring process described herein resolves problems related to comparing and evaluating the wide variety of polygenic models which could be used to predict a characteristic.

In this example, there are fifteen polygenic models that have been calibrated for a demographic that the individual belongs to, and the polygenic model with the highest score has been calibrated for people of age 32-35, of Pacific Islander ancestry, who are male and reside in the United States of America. Therefore, controller 164 uses this model in order to predict the characteristic of likelihood of developing Alzheimer's. The predictions made by the polygenic models indicate that the individual has moderate cardiovascular fitness with a likelihood of developing high cholesterol, and that the individual has a low likelihood of developing Alzheimer's as they age. Controller 164 transmits these predictions to notification server 140 via I/F 162, and notification server 140 generates a report that describes the predictions in detail. Notification server 140 inserts contextual information into the report indicating lifestyle changes that may help to increase health and reduce risk. Notification server 140 transmits the report to the individual at user device 110, and further transmits the report to third party server 130, which in this instance is a server for a hospital network.

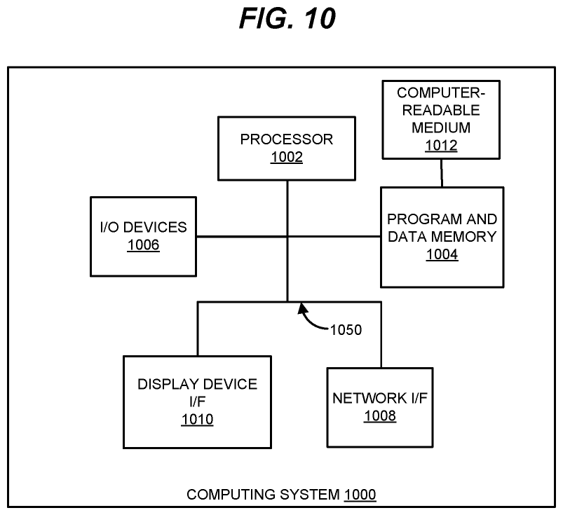

Embodiments disclosed herein can take the form of a hardware processor implementing programmed instructions, as hardware, as firmware operating on electronic circuitry, or various combinations thereof. In one particular embodiment, instructions stored on a computer readable medium are used to direct a computing system of user device 110, polygenic prediction server 160 and/or notification server 140 to perform the various operations disclosed herein. FIG. 10 illustrates an illustrative computing system 1000 operable to execute a computer readable medium embodying programmed instructions. Computing system 1000 is operable to perform the above operations by executing programmed instructions tangibly embodied on computer readable storage medium 1012. In this regard, embodiments of the invention can take the form of instructions (e.g., code) accessible via computer-readable medium 1012 for use by computing system 1000 or any other instruction execution system. For the purposes of this description, computer readable storage medium 1012 comprises any physical media that is capable of storing the program for use by computing system 1000. For example, computer-readable storage medium 1012 may be an electronic, magnetic, optical, electromagnetic, infrared, semiconductor device, or other non-transitory medium. Examples of computer-readable storage medium 1012 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Computing system 1000, which stores and/or executes the instructions, includes at least one processor 1002 coupled to program and data memory 1004 through a system bus 1050. Program and data memory 1004 include local memory employed during actual execution of the program code, bulk storage, and/or cache memories that provide temporary storage of at least some program code and/or data in order to reduce the number of times the code and/or data are retrieved from bulk storage (e.g., a spinning disk hard drive) during execution.

Input/output or I/O devices 1006 (including but not limited to keyboards, displays, pointing devices, etc.) may be coupled either directly or through intervening I/O controllers. Network adapter interfaces 1008 may also be integrated with the system to enable computing system 1000 to become coupled to other data computing systems or storage devices through intervening private or public networks. Network adapter interfaces 1008 may be implemented as modems, cable modems, Small Computer System Interface (SCSI) devices, Fibre Channel devices, Ethernet cards, wireless adapters, etc. Display device interface 1010 may be integrated with the system to interface to one or more display devices, such as screens for presentation of data generated by processor 1002.

1. A system comprising:
a genetic prediction server comprising:
a memory that stores polygenic models which predict characteristics of individuals based on genetic variants of the individuals, including a set of polygenic models for a characteristic that each perform a different analysis of genetic variants when making a prediction; and
a controller that receives an indication of genetic variants of an individual, determines that the individual belongs to a demographic, and selects, based on the demographic, a polygenic model from the set to predict the characteristic for the individual.

2. The system of claim 1 wherein:
each polygenic model in the set comprises a machine learning model that has been trained using known genotypes and known characteristics for members of a different demographic, and
the controller selects a machine learning model that has been trained using known genotypes and known characteristics for members of the demographic.

3. The system of claim 1 wherein:
the controller determines that the individual belongs to multiple demographics, and selects the polygenic model based on at least two of the multiple demographics.

4. The system of claim 3 wherein:
the controller determines a category for each of the multiple demographics, assigns a rank to each category, determines that the polygenic model has been calibrated for the demographic, determines that the demographic is within a category having a highest rank, and selects the polygenic model in response to determining that the demographic is within the category having the highest rank.

5. The system of claim 3 wherein:
the controller selects the polygenic model in response to determining that the polygenic model has been calibrated for members belonging to the multiple demographics.

6. The system of claim 1 wherein:
the indication provides genetic variants for less than a whole genome of the individual, and
the controller prevents selection of polygenic models that use different genetic variants as input than were provided in the indication.

7. The system of claim 1 wherein:
the indication reports the genetic variants of the individual in the form of a deoxyribonucleic acid (DNA) microarray, a whole exome, or a whole genome, and
each polygenic model uses genetic variants for a DNA microarray, a whole exome, or a whole genome as input.

8. A method comprising:
identifying polygenic models which predict characteristics of individuals based on genetic variants of the individuals, including a set of polygenic models for a characteristic that each perform a different analysis of genetic variants when making a prediction;
receiving an indication of genetic variants of an individual;
determining that the individual belongs to a demographic; and
selecting, based on the demographic, a polygenic model from the set to predict the characteristic for the individual.

9. The method of claim 8 wherein:
each polygenic model in the set comprises a machine learning model that has been trained using known genotypes and known characteristics for members of a different demographic, and the method further comprises:
selecting a machine learning model that has been trained using known genotypes and known characteristics for members of the demographic.

10. The method of claim 8 further comprising:
determining that the individual belongs to multiple demographics, wherein
selecting the polygenic model is based on at least two of the multiple demographics.

11. The method of claim 10 further comprising:
determining a category for each of the multiple demographics;
assigning a rank to each category;
determining that the polygenic model has been calibrated for the demographic;
determining that the demographic is within a category having a highest rank; and
selecting the polygenic model in response to determining that the demographic is within a category having the highest rank.

12. The method of claim 10 wherein:
selecting the polygenic model is performed in response to determining that the polygenic model has been calibrated for a population belonging to the multiple demographics.

13. The method of claim 8 wherein:
the indication provides genetic variants for less than a whole genome of the individual, and the method further comprises:
preventing selection of polygenic models that use different genetic variants as input than were provided in the indication.

14. The method of claim 8 wherein:
the indication reports the genetic variants of the individual in the form of a deoxyribonucleic acid (DNA) microarray, a whole exome, or a whole genome, and
each polygenic model uses genetic variants for a DNA microarray, a whole exome, or a whole genome as input.

15. A non-transitory computer readable medium embodying programmed instructions which, when executed by a processor, are operable for performing a method comprising:
receiving an indication of genetic variants of an individual;
identifying polygenic models which predict characteristics of individuals based on genetic variants of the individuals, including a set of polygenic models for a characteristic that each perform a different analysis of genetic variants when making a prediction;
determining that the individual belongs to a demographic; and
selecting, based on the demographic, a polygenic model from the set to predict the characteristic for the individual.

16. The medium of claim 15 wherein:
each polygenic model in the set comprises a machine learning model that has been trained using known genotypes and known characteristics for members of a different demographic, and the method further comprises:
selecting a machine learning model that has been trained using known genotypes and known characteristics for members of the demographic.

17. The medium of claim 15 wherein:
determining that the individual belongs to multiple demographics, wherein
selecting the polygenic model is based on at least two of the multiple demographics.

18. The medium of claim 17 wherein the method further comprises:
determining a category for each of the multiple demographics;
assigning a rank to each category;
determining that the polygenic model has been calibrated for the demographic;
determining that the demographic is within a category having a highest rank; and
selecting the polygenic model in response to determining that the demographic is within a category having the highest rank.

19. The medium of claim 17 wherein:
selecting the polygenic model is performed in response to determining that the polygenic model has been calibrated for a population belonging to the multiple demographics.

20. The medium of claim 15 wherein:
the indication provides genetic variants for less than a whole genome of the individual, and the method further comprises:
preventing selection of polygenic models that use different genetic variants as input than were provided in the indication.
